(19) United States
(12) Patent Application Publication
(10) Pub. No.: US 2011/0027046 A1
(43) Pub. Date: Feb. 3, 2011

(54) SELF-PIERCING BLIND NUT INSERT

(76) Inventors: Victor Lanni, Ray Township, MI (US); Paul Purdy, Holly, MI (US)

Correspondence Address: CLARK HILL PLC, 150 NORTH MICHIGAN AVENUE, SUITE 2700, CHICAGO, IL, 60601, US

(21) Appl. No.: 12/902,685

(22) Filed: Oct. 12, 2010

Related U.S. Application Data
(63) Continuation of application No. 11/769,121, filed on Jun. 27, 2007.
(60) Provisional application No. 60/820,027, filed on Jul. 21, 2006.

(51) Int. Cl. F16B 29/00

(52) U.S. Cl. 411/427

(57) ABSTRACT

A threaded insert which has a cutting edge on its external surface. The cutting edge is configured to punch a hole in a workpiece while leaving a slug intact, still connected to the workpiece structure. The cutting edge is configured such that no backup die need be utilized to form the hole in the workpiece. The threaded insert includes an internal threaded portion, and a deformable side wall which is configured to deform upon installation of the threaded insert, to forming a blind-side bulb against the workpiece, and against the slug. The threaded insert is configured such that an installation tool can be threaded into the threaded insert, the threaded insert pierced through the workpiece. Then, the installation tool is actuated to cause the deformable side wall of the threaded insert to plastically deform and form the blind-side bulb.

### RELATED APPLICATION (PRIORITY CLAIM)

This application is a continuation of U.S. patent application Ser. No. 11/769,121, filed Jun. 27, 2007, which claims the benefit of U.S. Provisional Application Ser. No. 60/820,027, filed Jul. 21, 2006, both of which are hereby incorporated herein by reference in their entirety.

### BACKGROUND

The present invention generally relates to blind threaded inserts, and more specifically relates to a blind threaded insert which is configured to pierce a workpiece without use of a backing die, and which is configured to leave a slug attached to the workpiece after piercing.

Due to their advantage in stiffness-to-weight ratio, tubular structural members are being incorporated into new automotive designs in increasing numbers. These tubular components are often hydroformed and, regardless of how they are formed, create a challenge for fastening mating parts. Being hollow, fastening all the way through the tube tends to crush the tube. Therefore, in many cases, blind insert nuts are used to fasten to one side only. In the present application, the term “blind” means that there is only access to one side of a workpiece, with the side of the workpiece to which one does not have access being referred to as the “blind” side of the workpiece. Conventional staking fasteners require a backup die, but the nature of a tube typically precludes the use of a backup die prior to installation. As such, blind threaded inserts typically require that a hole be formed in the tube prior to installation of the blind threaded insert. Forming such holes requires extra operations, such as drilling or laser cutting. These extra operations consume time and incur extra costs.

There are several U.S. patents directed to piercing holes in tubes, such as those which are typically used in the automotive industry. For example, U.S. Pat. No. 5,398,533 discloses an apparatus for in-die piercing of a tube as the tube is being hydroformed. The apparatus utilizes a die, and produces a slug which is thereafter ejected. Typically, it is important to get the slug out of a tube before the tube is used because otherwise the slug rattles in the tube and creates noise, which is undesirable. Similarly, U.S. Pat. No. 5,666,840 discloses an apparatus which pierces a pair of aligned holes through a tube as the tube is being hydroformed. A die is used, and two slugs are formed which are ejected through the die.

U.S. Pat. No. 6,305,201 discloses an apparatus which forms holes in a hydroformed part, and a plurality of slugs are formed which remain intact. However, the hole cutting operation is a separate operation from a possible secondary operation of installing a threaded insert into the holes. U.S. Pat. No. 6,658,908 discloses a punch for piercing and sealing hydroformed parts. The punching operation produces a slug which detaches from the structure's wall. Similarly, U.S. Pat. No. 6,672,120 discloses an in-die hydroforming apparatus which is configured to cut a slug out of a hydroformed part.

### OBJECTS AND SUMMARY

An object of an embodiment of the present invention is to provide a threaded insert which is configured to pierce a hole in a workpiece.

Another object of an embodiment of the present invention is to provide a threaded insert which is configured to pierce a hole in a workpiece, and is configured to produce a slug which remains intact, still connected to the workpiece.

Yet another object of an embodiment of the present invention is to provide a threaded insert which is configured such that it can be used to pierce a hole in a workpiece, without having to use a backup die.

Briefly, and in accordance with at least one of the foregoing objects, an embodiment of the present invention provides a threaded insert which has a cutting edge on its external surface. The cutting edge is configured to punch a hole in a workpiece while leaving a slug intact, still connected to the workpiece structure. The cutting edge is configured such that no backup die need be utilized to form the hole in the workpiece. The threaded insert includes an internal threaded portion, and a deformable side wall which is configured to deform upon installation of the threaded insert. More specifically, the deformable side wall is sufficiently ductile to plastically deform by action of an installation tool, to form a blind-side bulb against the workpiece, and against the slug.

The threaded insert is configured such that an installation tool can be threaded into the threaded insert, the threaded insert pierced through the workpiece, thereby forming a hole with a slug left intact. Then, the installation tool is actuated to cause the deformable side wall of the threaded insert to plastically deform and form a blind-side bulb against the workpiece, against the slug.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of the blind side of a workpiece after a threaded insert in accordance with an embodiment of the present invention has been installed;

FIGS. 2-5 are a sequence of partial cross-sectional views showing the threaded insert of FIG. 1 being installed;

FIGS. 6a-6g are a sequence of schematic views illustrating a first method of installing the threaded insert of FIGS. 1-5;

FIGS. 7a-7f are a sequence of schematic views illustrating a second method of installing the threaded insert of FIGS. 1-5; and

FIGS. 8a-8f are a sequence of schematic views illustrating a third method of installing the threaded insert of FIGS. 1-5.

### DESCRIPTION

While the present invention may be susceptible to embodiment in different forms, there are shown in the drawings, and herein will be described in detail, embodiments thereof with the understanding that the present description is to be considered an exemplification of the principles of the invention and is not intended to limit the invention to that as illustrated and described herein.

Threaded inserts are well known in the industry. However, prior art threaded inserts are designed such that a hole must be pre-formed in a workpiece before the threaded insert is installed. The present invention is directed at providing a threaded insert which is configured such that it can pierce a hole in a workpiece, without having to use a backup die, and such that a slug remains attached to the workpiece.

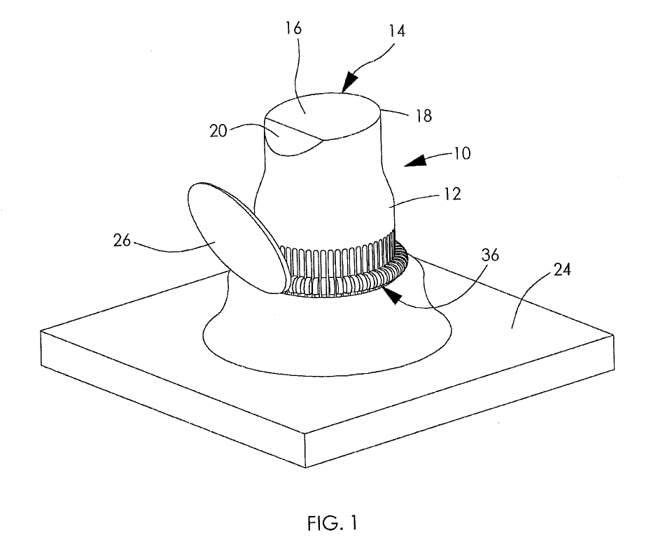

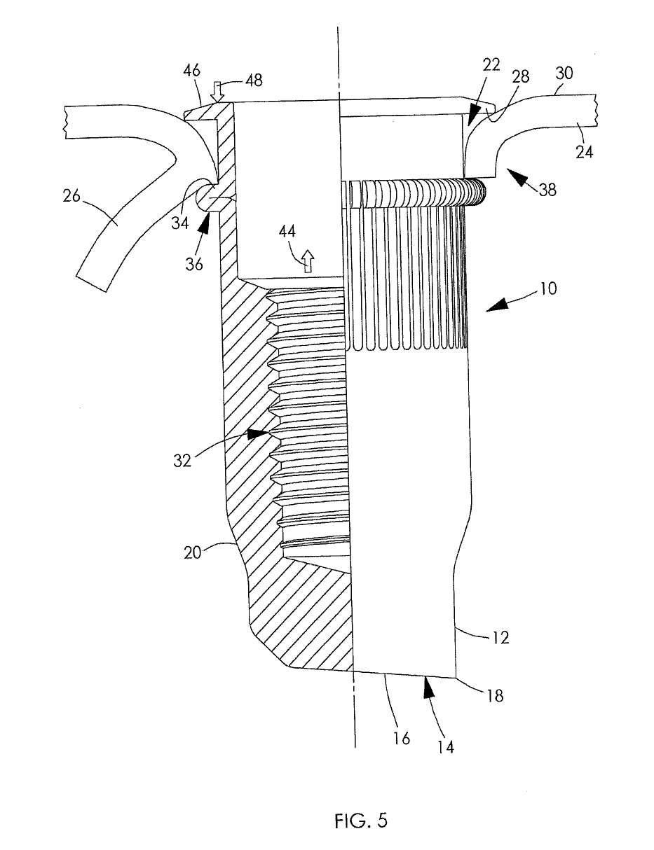

FIGS. 1-5 illustrate a threaded insert 10 which is in accordance with an embodiment of the present invention. The threaded insert 10 has an external surface 12 which provides a tip 14, and the tip 14 includes a leading surface 16 having a cutting edge 18, and an angled surface 20 proximate the leading surface 16. The tip 14 is configured to punch a hole 22 in a workpiece 24 while leaving a slug 26 intact, still connected to the workpiece structure 24, as shown in FIGS. 1, 4 and 5. The cutting edge 18 is configured such that no backup die need be utilized to form the hole 22 in the workpiece 24. The threaded insert 10 also includes a lip or shoulder 28 which is configured to contact and seat against the non-blind, accessible side 30 of the workpiece, as shown in FIG. 5.

The threaded insert 10 also includes an internal threaded portion 32, and a deformable side wall 34 which is configured to deform upon installation of the threaded insert 10, as shown in FIG. 5. More specifically, the deformable side wall 34 is sufficiently ductile to plastically deform by action of an installation tool, to form a bulb 36 against the blind side 38 of the workpiece 24, and against the slug 26.

Installation of the threaded insert 10 can be performed with the use of a conventional spin-pull installation tool, where the tool includes a mandrel which can spin as well as extend and retract. Such installation tools are well known in the industry

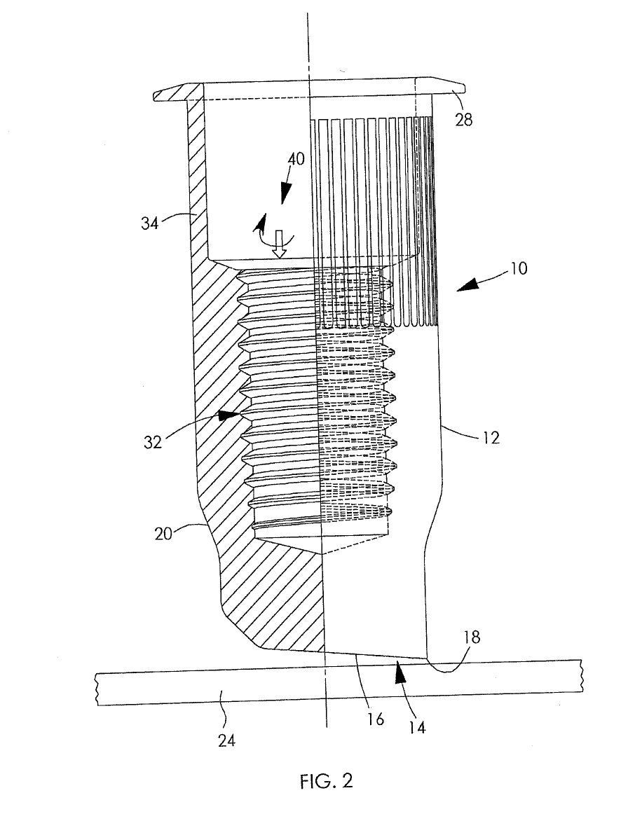

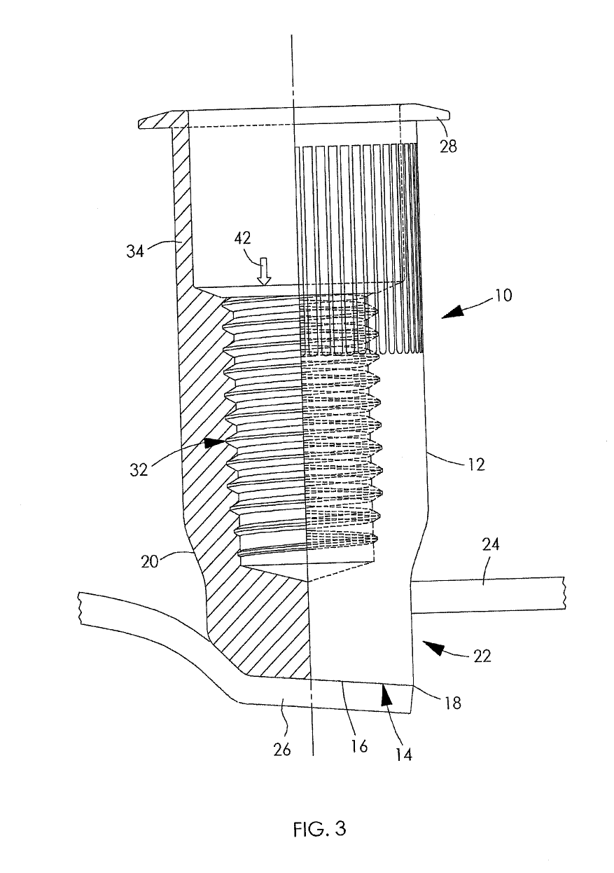

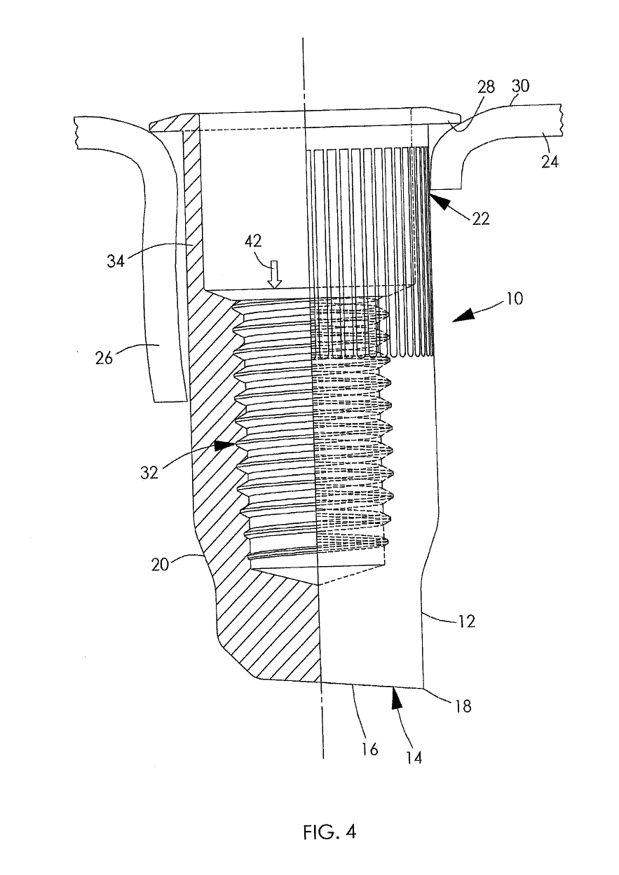

As shown in FIGS. 2-5, the threaded insert 10 is configured such that a mandrel of a driver (i.e., installation tool) can be rotated such that it threads (said threading action represented by arrows 40 in FIG. 2) into the threaded portion 32 of the threaded insert 10. Then, the mandrel is axially, non-rotatably advanced toward the workpiece 24 (said advancing action represented by arrow 42 in FIG. 2), causing the threaded insert 10 to pierce through the workpiece 24, as shown in FIGS. 3-4. The configuration of the tip 14 of the threaded insert 10 provides that when the threaded insert 10 pierces the workpiece 24, a hole 22 is formed with a slug 26 left intact, still attached to the workpiece 24. Then, the installation tool is actuated (said actuation represented by arrow 44 in FIG. 5) to cause the deformable side wall 34 of the threaded insert 10 to plastically deform and form a blind-side bulb 36 against the workpiece 24, and against the slug 26.

With regard to actuation of the installation tool which causes the threaded insert 10 to set, the threaded insert 10 is shown in FIGS. 1-5 as having a closed tip 14. As such, “spin-pull” technology is used to install the threaded insert 10. More specifically, the installation tool spins the mandrel into the threaded insert 10 (i.e., to obtain threaded engagement with the threaded portion 32 of the threaded insert 10). Then, the installation tool advances the mandrel (i.e., moves the mandrel forward toward the workpiece 24), causing the threaded insert 10 to pierce the workpiece 24, as shown in FIGS. 3-4 . Subsequently, the installation tool retracts the mandrel (i.e., moves the mandrel away from the workpiece 24) while maintaining contact with the top surface 46 of the threaded insert (said contact represented by arrow 48 is FIG. 5), causing the threaded insert 10 to set. Finally, the installation tool spins the mandrel out of threaded engagement with the threaded insert 10.

While the threaded insert has been shown and described as having a closed tip 14, the threaded insert 10 can instead be provided as having an open tip, where the threaded portion 32 extends all the way through the threaded insert. In such case, the threaded insert could be installed using a “spin-spin” method instead of a “spin-pull” method. Specifically, while the threaded insert having the closed tip 14 has been described as being installed by spinning a mandrel into the threaded insert 10 and then subsequently pulling up on the mandrel to cause the threaded insert 10 to set, if the threaded insert 10 were provided with an open tip, the threaded insert 10 can be set by merely continuing to spin the mandrel, as opposed to pulling up on the mandrel. This “spin-spin” technology, like “spin-pull” technology, is well known in the art with regard to threaded inserts.

With regard to manufacturing the threaded insert, the threaded insert can be cold formed. U.S. patent application Ser. No. 10/415,178 discloses a method of manufacturing a blind threaded insert, and that application is hereby incorporated herein by reference in its entirety.

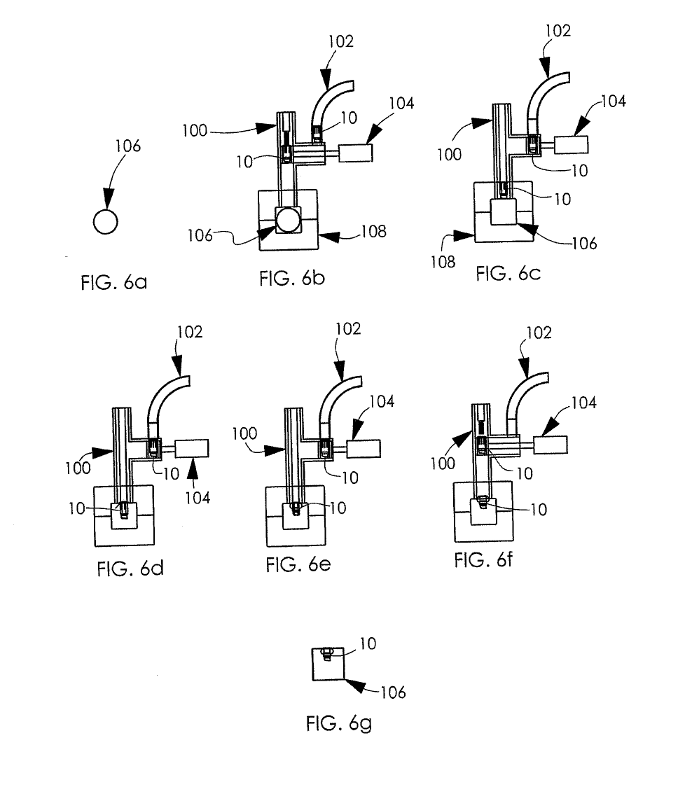

FIGS. 6a-6g, 7a-7f and 8a-8f illustrate three different automated methods which can be used to install the threaded insert 10 shown in FIGS. 1-5. Each method includes the use of a driver (i.e., installation tool) 100 having a mandrel which can spin as well as extend and retract. Such installation tools are well known in the industry. Each method also includes the use of a feed mechanism 102 which is used to automatically feed threaded inserts for automated installation, and a shuttle mechanism 104 which is used to shuttle thread inserts one-by-one into position for installation by the driver 100.

FIGS. 6a-6g illustrate the threaded insert 10 being installed in a hydroforming die with hydraulic pressure used as a backing. FIG. 6a illustrates a tube 106 provided in its raw state. As shown in FIG. 6b, the tube 106 is loaded into a die 108, the driver 100 is retracted and a threaded insert 10 is shuttled into place. As shown in FIG. 6c, the tube 106 is then pressurized in the die 108 and this causes the tube 106 to take the shape of the die 108. The driver (i.e., a mandrel of the driver) 100 is threadably engaged with the insert 10, which is held in position above the tube 106, and the next insert 10 is fed into the shuttle 104. As shown in FIG. 6d, the driver 100 presses the insert 10 through the tube 106, while the tube 106 is pressurized (see also FIGS. 2-4). As discussed above, the tip 14 of the insert 10 is configured such that the slug 26 remains attached during the piercing operation. As shown in FIG. 6e, once the insert 10 is in the correct position, the mandrel of the driver 100 is pulled up, causing the insert 10 to collapse and set (unless “spin-spin” technology is utilized, in which case the mandrel is spun forward) (see also FIG. 5). As shown in FIG. 6f, once the insert 10 is set, the mandrel is unthreaded from the insert 10 and is retracted. FIG. 6g illustrates the tube 106 in the finished state, with the insert 10 installed.

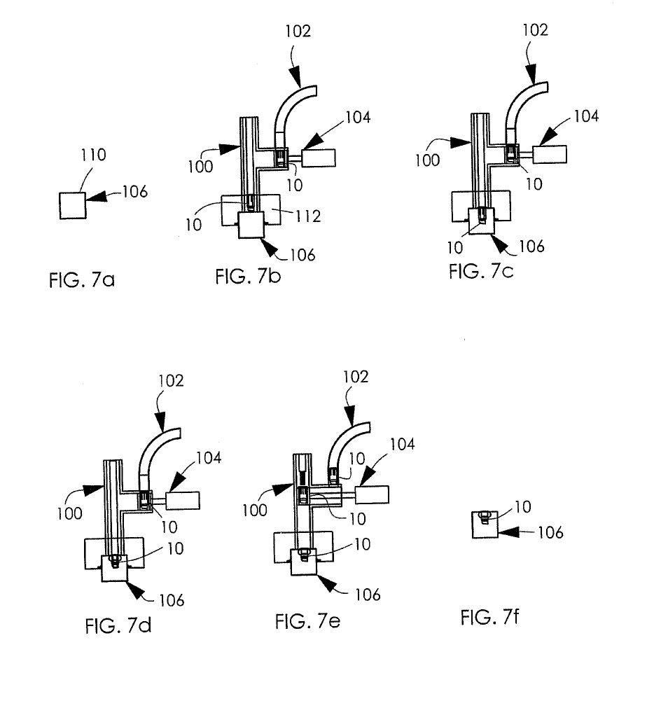

FIGS. 7a-7f illustrate the threaded insert 10 being installed by firing it through the wall 110 of an unsupported tube 106 using velocity similar to when a nail gun is used. FIG. 7a illustrates a tube 106 provided in its raw state. As shown in FIG. 7b, the mandrel of the driver 100 is threaded into the threaded insert 10, and the insert 10 is pressed against the tube 106. Simultaneously, preferably a mechanism or magnetic force is used to hold the tool 112 against the tube 106, as this will help absorb some of the impact force caused by the insert 10 penetrating the tube 106. As shown in FIG. 7c, the driver 100 then fires the insert 10 under high velocity so that the insert 10 penetrates the tube 106 (see also FIGS. 2-4). As discussed above, the tip 14 of the insert 10 is configured such that the slug 26 remains attached during the piercing operation. As shown in FIG. 7d, once the insert 10 is in the correct position, the mandrel of the driver 100 is pulled up, causing the insert 10 to collapse and set (unless “spin-spin” technology is utilized, in which case the mandrel is spun forward) (see also FIG. 5). As shown in FIG. 7e, once the insert 10 is set, the mandrel is unthreaded from the insert 10 and the driver 100 is retracted. FIG. 7f illustrates the tube 106 in the finished state, with the insert 10 installed.

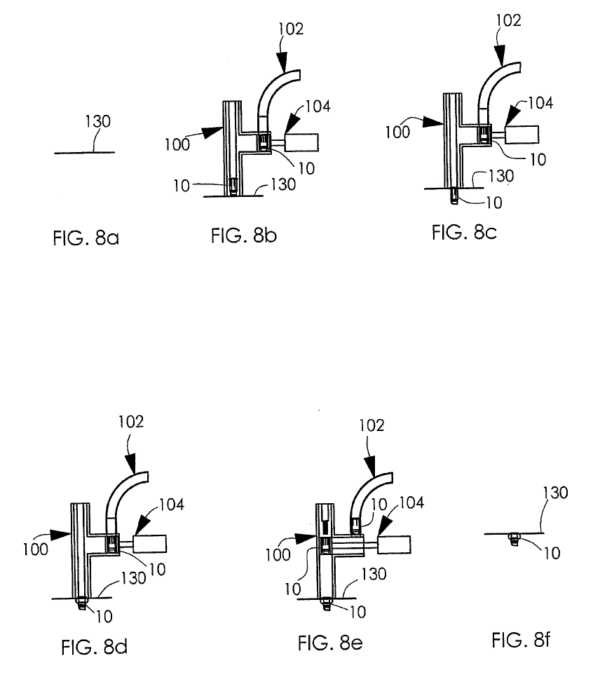

FIGS. 8a-8f illustrate the threaded insert 10 being installed by firing it through a flat sheet 130 of an unsupported material using velocity similar to when a nail gun is used. FIG. 8a illustrates the flat sheet 130 in its raw state. As shown in FIG. 8b, the tool 100 is pressed against the sheet, the mandrel of the driver 100 is threaded into the threaded insert 10, and the insert 10 is pressed against the sheet 130. Simultaneously, preferably a mechanism or magnetic force is used to hold the tool 100 against the sheet 130, as this will help absorb some of the impact force caused by the insert 10 penetrating the sheet 130. As shown in FIG. 8c, the driver 100 then fires the insert 10 under high velocity so that the insert 10 penetrates the sheet 130 (see also FIGS. 2-4). As discussed above, the tip 14 of the insert 10 is configured such that the slug 26 remains attached during the piercing operation. As shown in FIG. 8d, once the insert 10 is in the correct position, the mandrel of the driver 100 is pulled up, causing the insert 10 to collapse and set (unless “spin-spin” technology is utilized, in which case the mandrel is spun forward) (see also FIG. 5). As shown in FIG. 8e, once the insert 10 is set, the mandrel is unthreaded from the insert 10 and the driver 100 is retracted. FIG. 8f illustrates the sheet 130 in the finished state, with the insert 10 installed.

While embodiments of the present invention are shown and described, it is envisioned that those skilled in the art may devise various modifications of the present invention without departing from the spirit and scope of the disclosure.

What is claimed is:

1. A self-piercing insert for punching a hole in a workpiece, said self-piercing insert comprising a single piece body having an external surface and a pre-formed internal threaded portion, said external surface of said single piece body providing a tip which is configured to punch the hole in the workpiece, wherein said tip includes an angled leading surface having a periphery defining a cutting edge of said angled leading surface.

2. A self-piercing insert as recited in claim 1, wherein said tip is closed.

3. A self-piercing insert as recited in claim 1, wherein said tip is configured to punch the hole in the workpiece while leaving a slug intact, still connected to the workpiece.

4. A self-piercing insert as recited in claim 1, wherein the cutting edge is configured such that no backup die need be utilized to form the hole in the workpiece.

5. A self-piercing insert as recited in claim 1, further comprising a deformable side wall which is configured to deform upon installation of the self-piercing insert into the workpiece.

6. A self-piercing insert as recited in claim 5, wherein the cutting edge is configured to punch the hole in the workpiece while leaving a slug intact, still connected to the workpiece, wherein the deformable side wall is sufficiently ductile to plastically deform, to form a blind-side bulb against the workpiece, and against the slug.

7. A self-piercing insert as recited in claim 1, wherein the tip further includes an angled trailing surface extending from a portion of said periphery of said angled leading surface, wherein said portion of said periphery of said angled leading surface does not define said cutting edge of said angled leading surface.

8. A self-piercing insert as recited in claim 1; further comprising a shoulder which is configured to contact and seat against a non-blind, accessible side of the workpiece.

9. A self-piercing insert for punching a hole in a workpiece, said self-piercing insert comprising:
a single piece body having an external surface and an internal threaded portion, said external surface of said single piece body providing a tip which is configured to punch the hole in the workpiece, wherein said tip includes an angled leading surface in the form of a truncated closed curve which defines a curved outer edge and a straight outer edge of said angled leading surface, said curved outer edge defining a cutting edge of said tip.

10. The self-piercing insert as recited in claim 9, wherein said tip further includes an angled trailing surface in the form of a truncated closed curve which defines a curved outer edge and a straight outer edge of said angled trailing surface, said straight outer edge of said angled trailing surface and said straight outer edge of said angled leading surface being the same.

11. The self-piercing insert as recited in claim 10, wherein said angled leading surface is provided at a different angle than said angled trailing surface.

12. The self-piercing insert as recited in claim 9, wherein a portion of said cutting edge of said tip which first contacts the workpiece when said self-piercing insert punches the hole in the workpiece is offset from a longitudinal axis of said self-piercing insert.

13. The self-piercing insert as recited in claim 12, wherein when said self-piercing insert punches the hole in the workpiece, said longitudinal axis of said self-piercing insert is perpendicular to a surface of the workpiece in which the hole is to be punched.

14. The self-piercing insert as recited in claim 13, wherein said tip is configured to punch the hole in the workpiece while leaving a slug intact, still connected to the workpiece.

15. The self-piercing insert as recited in claim 9, wherein said tip is closed.

16. The self-piercing insert as recited in claim 9, wherein said cutting edge is configured such that no backup die need be utilized to form the hole in the workpiece.

17. The self-piercing insert as recited in claim 9, further comprising a deformable side wall which is configured to deform upon installation of said self-piercing insert into the workpiece.

18. The self-piercing insert as recited in claim 17, wherein said cutting edge is configured to punch the hole in the workpiece while leaving a slug intact, still connected to the workpiece, wherein said deformable side wall is sufficiently ductile to plastically deform, to form a blind-side bulb against the workpiece, and against the slug.

19. The self-piercing insert as recited in claim 9, further comprising a shoulder which is configured to contact and seat against a non-blind, accessible side of the workpiece.

20. A self-piercing insert for punching a hole in a workpiece, said self-piercing insert comprising:
a single piece body having,
an internal threaded portion,
an external surface which provides a tip that is configured to punch the hole in the workpiece, wherein said tip includes an angled leading surface and an angled trailing surface, each of said angled leading and trailing surfaces being in the form of truncated closed curves which define curved outer edges and straight outer edges, said straight outer edges of said angled leading and trailing surfaces being the same, said curved outer edge of said angled leading surface defining a cutting edge of said tip, said angled leading surface being provided at a different angle than said angled trailing surface,
a deformable side wall, and
a shoulder,
wherein when said self-piercing insert punches the hole in the workpiece, a portion of said cutting edge of said tip which first contacts the workpiece is offset from a longitudinal axis of said self-piercing insert, said longitudinal axis of said self-piercing insert being perpendicular to a surface of the workpiece in which the hole is to be punched, said tip being configured to punch the hole in the workpiece while leaving a slug intact, still connected to the workpiece, said deformable side wall being sufficiently ductile to plastically deform in order to form a blind-side bulb against the workpiece and against the slug, said shoulder configured to contact and seat against a non-blind, accessible side of the workpiece.
